(19) United States
(12) Patent Application Publication
(10) Pub. No.: US 2026/0200407 A1
(43) Pub. Date: Jul. 16, 2026

(54) TREAD EXTENSION ASSEMBLY FOR A PIVOTING STAIRCASE

(71) Applicant: MORRYDE INTERNATIONAL, INC., Elkhart, IN (US)

(72) Inventors: Anthony J. Granzotto, Constantine, MI (US); Christopher Taylor, Elkhart, IN (US)

(21) Appl. No.: 19/449,615

(22) Filed: Jan. 15, 2026

Related U.S. Application Data
(60) Provisional application No. 63/745,475, filed on Jan. 15, 2025.

(51) Int. Cl. B60R 3/02

(52) U.S. Cl. CPC B60R 3/02

(57) ABSTRACT

Tread extension assemblies include a mount configured to releasably couple to the lower end of the pivoting staircase and an extension tread coupled to the mount. The mount is configured to position the extension tread below a lowermost tread of the pivoting staircase.

### CROSS-REFERENCE TO RELATED APPLICATION

This application claims the benefit of priority to U.S. Provisional Application No. 63/745,475, filed January 15, 2025, which is hereby incorporated by reference herein in its entirety.

### FIELD OF THE DISCLOSURE

The present disclosure generally relates to staircases for recreational vehicles.

### BACKGROUND

Pivoting staircases for recreational vehicles (RVs) help users easily enter and exit the RV. Typically, RVs, which can be towable units or motorhomes, are well above the ground upon which they rest. To provide traction for a user and prevent or minimize a user’s foot from slipping front-to-back or back-to-front, each of the treads of the staircase can include ribs that extend laterally thereacross. When deployed, uneven terrain adjacent to or underneath the RV can cause the pivoting staircase to be spaced from the ground a distance greater than a typical tread height.

### BRIEF DESCRIPTION OF THE DRAWINGS

FIG. 1 is a perspective view of a pivoting staircase with a first example tread extension assembly in accordance with the teachings of the present disclosure.

FIG. 2 is a perspective view of the pivoting staircase and tread extension assembly of FIG. 1.

FIG. 3 is a sectional view of the pivoting staircase and tread extension assembly of FIG. 1.

FIG. 4 is a perspective view of a pivoting staircase with a second example tread extension assembly in accordance with the teachings of the present disclosure.

FIG. 5 is a perspective view of the pivoting staircase and tread extension assembly of FIG. 4.

FIG. 6 is a perspective view of a pivoting staircase with a third example tread extension assembly in a use position in accordance with the teachings of the present disclosure.

FIG. 7 is a perspective view of the pivoting staircase and tread extension assembly of FIG. 6 with the tread extension assembly in the use position.

FIG. 8 is a perspective view of the pivoting staircase and tread extension assembly of FIG. 6 with the tread extension assembly in a storage position.

FIG. 9 is a perspective view of the pivoting staircase and tread extension assembly of FIG. 6 with the tread extension assembly in a storage position.

FIG. 10 is a perspective view of a pivoting staircase with a fourth example tread extension assembly in accordance with the teachings of the present disclosure.

FIG. 11 is a perspective view of the pivoting staircase and tread extension assembly of FIG. 10.

FIG. 12 is a perspective view of a pivoting staircase with a fifth example tread extension assembly in a use position in accordance with the teachings of the present disclosure.

FIG. 13 is a cross-sectional view of the pivoting staircase and tread extension assembly of FIG. 12.

FIG. 14 is a perspective view of the pivoting staircase and tread extension assembly of FIG. 12 with the tread extension in a storage position.

FIG. 15 is a cross-sectional view of the pivoting staircase and tread extension assembly of FIG. 14.

### DETAILED DESCRIPTION

Pivoting staircases and tread extension assemblies for pivoting staircases are described herein. The tread extension assemblies provide a releasably attachable tread that to be positioned below a lowermost tread of the pivoting staircase. The tread extension assemblies can advantageously be utilized to bridge a gap between a ground surface and the lowermost tread that may be larger than a typical tread height due to ground surface variations or positioning of the pivoting staircase.

An example pivoting staircase 10 is shown in the figures. The staircase has an upper end 12, an opposite, lower end 14, and one or more treads 16 spaced between the upper and lower ends 12, 14. The staircase 10 further includes a pivot connection 18 at the upper end 12 to pivotably couple the staircase 10 to an elevated structure 20, such as a recreational vehicle. The treads 16 include an upper surface 22 configured to be stepped upon by a user when climbing or descending the staircase 10.

As shown, the staircase 10 includes a pair of stringers 24 that are spaced from and generally parallel to each other. The one or more treads 16 extend between the stringers 24 and have lateral ends 26 fixed to the stringers 24. The staircase 10 can include any suitable number of treads 16, such as one, two, three, four, five, or more. Further, the treads 16 can be fixed to the stringers 24 in any suitable way. For example, the lateral ends 26 of the treads 16 can be welded to an interior surface 28 of the stringers 24, can be secured to the stringers 24 using one or more fasteners 30, such as bolts, screws, rivets, etc., can be secured to the stringers 24 with interlocking components, and so forth.

The stringers 24 can have any suitable form. For example, the stringers 24 can include at least a wall 32 to couple to the tread 16. The wall 32 can have a substantially unbroken profile, other than openings extending therethrough for fasteners and other uses, or can be divided into two or more portions connected to other walls or structures. In the illustrated example, the stringers 24 have a tubular configuration with the wall 32 providing the interior surface 28 for engaging the treads 16, an exterior wall 34, and sidewalls 36 extending therebetween to define an interior 38 extending the length of the stringers 24.

The staircase 10 is pivotable about the pivot connection 18 between a use position as shown in the figures and a storage position above or within the elevated structure 20, such as extending generally vertically away from the pivot connection 18. In the use position, the staircase 10 extends downwardly and forwardly relative to the elevated structure 20 to contact or be disposed adjacent to a ground or other ground surface 40. In the use position, the staircase 10 provides access to the elevated structure 20. In the storage position, the staircase 10 is pivoted about the pivot connection 18 to or through a vertical orientation positioned over the pivot connection 18. For example, the staircase 10 can be held in a vertical orientation disposed over the pivot connection 18 or can be pivoted past the vertical orientation to a rearwardly angled or horizontal orientation.

While pivoting staircases 10 can be utilized in a variety of locations, they are particularly useful for recreational vehicles/trailers 42 that are moved between various locations and have elevated structures 20 (e.g., floors) relative to the ground surface 40 (e.g., ground). In one example, the staircase 10 can be mounted in a door opening 44 within a wall 46 of the recreational vehicle 42 separating an indoor space from an outdoor space. The door opening 44 receives a door 48 that is pivotable between an open position and a closed position.

The working parts of the staircase 10 are designed to allow operation of the door 48 when the staircase 10 is in either its use or storage position. With the door 48 open, and with the door 48 remaining open, the staircase 10 may be moved to its use position. Once the staircase 10 is in its use position, the door 48 may be closed over the threshold plate 54. With the staircase 10 in its storage position and the door 48 in its closed position, the entire staircase 10 and pivot connection 18 located within the indoor space.

The pivot connection 18 can take any suitable form. In a first example, as shown in the figures, the pivot connection 18 can include a hinge 50 connected to the upper end 12 of the staircase 10 and to the elevated structure 20. The hinge 50 includes a floor mounting portion 52 and a threshold plate 54 that pivots about a pivot axis with respect to the floor mounting portion 52. The floor mounting portion 52 is adapted to be mounted to the elevated structure 20 by any suitable mechanism, including fasteners, welding, adhesive, and so forth. In one example, the floor mounting portion 52 can be mounted within the indoor space adjacent to the door 48 such that the staircase is pivotable about the hinge 50 to the outdoor space.

As shown, the staircase 10 further includes legs 56 at the lower end 14 that are configured to engage the ground surface 40 (e.g., a ground surface) adjacent to the elevated structure 20. In some examples, the legs 56 are adjustable to extend and retract relative to the stringers 24 to accommodate variations in ground surface levels due to hills, slopes, and the like. Further, the legs 56 can include feet 58 pivotably coupled thereto to adapt to the ground surface 40 and brace the staircase 10 against the ground surface 40 when deployed.

The adjustable legs 56 can have any suitable configuration. In some examples, the legs 56 telescope out from the interior 38 of the stringers 24 and are secured in place with a lock 60, such as a pin or the like, extending through aligned openings in one or more walls 32, 34, 36 of the stringer 24 and the legs 56.

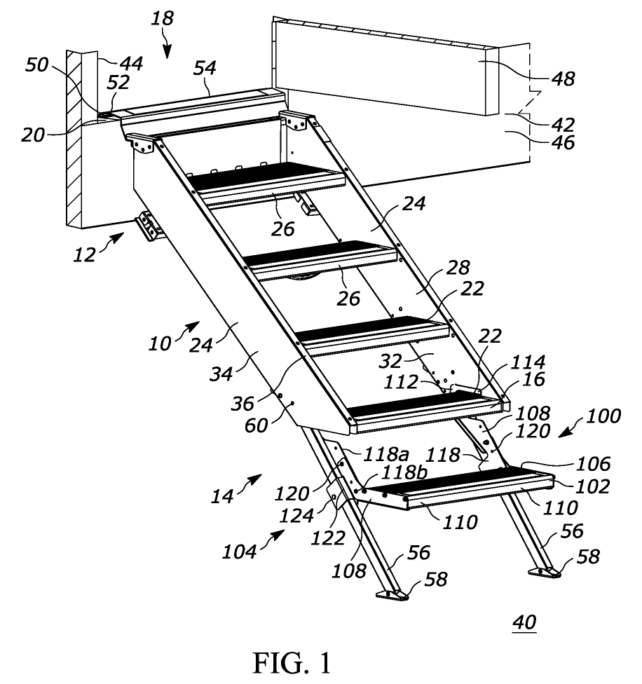

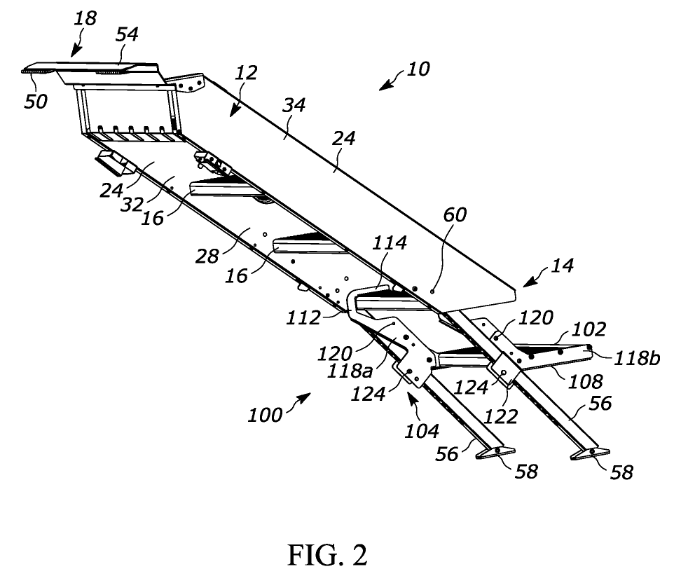

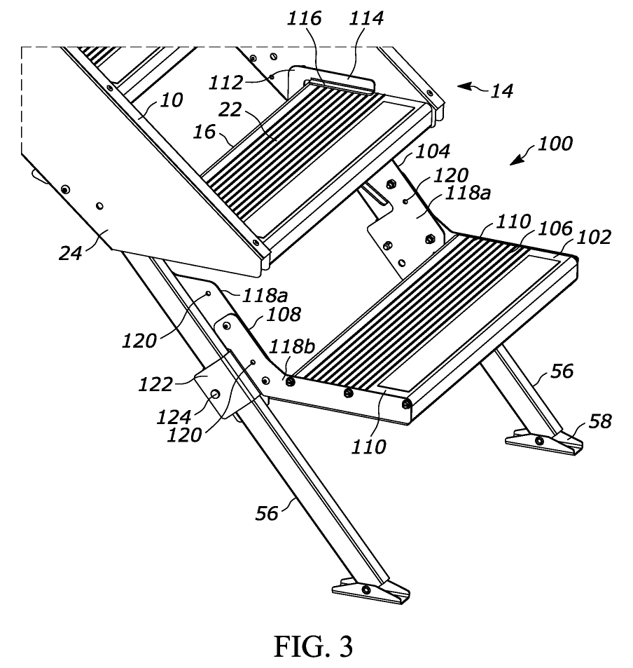

A first example extension tread assembly 100 is shown in FIGS. 1-3. The extension tread assembly 100 includes an extension tread 102 and a mount 104 configured to releasably couple the extension tread assembly 100 to the lower end 14 of the pivoting staircase 10 to position the extension tread 102 below a lowest one of the one or more treads 16 of the pivoting staircase 10. The extension tread 102 is coupled to the mount 104 and has an upper surface 106 configured to support a person thereon. As shown, the mount 104 includes bracket assemblies 108 coupled to lateral edges 110 of the extension tread 102.

The mount 104 includes one or more hooks 112 that are configured to engage the lowermost tread 16. For example, the hooks 112 include an upper portion 114 that is configured to extend across the upper surface 22 of the lowermost tread 16. Alternatively, the hooks 112 can be configured to connect to a lower surface of the tread 16, or the tread 16 can include one or more ledges, recesses, or cavities defined in or extending from the tread 16 to receive the hooks 112. By one approach, the mount 104 includes two hooks 112 that extend over the lateral ends 26 of the tread 16. Of course, one central hook or more than two hooks could be utilized. To provide a more stable support, the upper portions 114 of the hooks 112 can include a laterally extending flange 116 (e.g., inwardly or outwardly along the tread 16) that is configured to extend across the upper surface 22 of the lowermost tread 16.

In some examples, each bracket assembly 108 includes a plurality of brackets 118 that have a plurality of coupling locations 120 therebetween (i.e., the brackets 118 can be coupled together at two or more different locations). The coupling locations 120 are configured to impart different lengths to the bracket assemblies 108 to position the extension tread 102 at a particular distance from the lowermost tread 16. Due to this, the coupling locations 120 allow a user to select one of the plurality of coupling locations 120 to place the extension tread 102 at a desired distance relative to the lowermost tread 16. For example, the coupling locations 120 can be openings that align to receive a pin or other fastener therethrough to secure the brackets 118 together. Alternatively, the coupling locations 120 can be interlocking structures (e.g., hooks and sockets, etc.). In the illustrated example, each of bracket assemblies 108 include an upper bracket 118a that is configured to couple to the lowermost tread 16 and a lower bracket 118b that is configured to couple to one of the lateral edges 110 of the extension tread 102. Additional brackets can be provided in a linkage, if desired.

In addition to the hooks 112, the mount 104 (e.g., the bracket assemblies 108) can include braces 122 that are configured to engage the legs 56 of the staircase 10 to provide additional support for the extension tread 102. The braces 122 can include a wall that rests on an upper surface of the legs 56. In some examples, the braces 122 further include sidewalls, such that the braces 122 have a U-shaped configuration that extends around the sides of the legs 56. The U-shaped configuration provides additional lateral support to the extension tread assembly 100. If desired, lock members 124 (e.g., pins, latches, etc.) can be releasably coupled to the braces 122 behind the legs 56 to secure the bracket assemblies 108 to the legs 56. As shown, in examples with the upper and lower brackets 118a, 118b, the upper bracket 118a can have a planar configuration that extends along an interior surface of the leg 56 and the lower bracket 118b can include a bent portion that extends along the upper surface of the leg 56 and along an outer surface of the leg 56. When the upper and lower brackets 118a, 118b are secured together, the brackets 118a, 118b capture the leg 56 therebetween.

To use the extension tread assembly 100, the pivoting staircase 10 can be moved from the storage position to the use position to contact the ground surface 40 (e.g., ground surface). This can include adjusting a length of the legs 56 so that the staircase 10 securely engages the ground surface 40. Thereafter, the tread extension assembly 100 is releasably secured to the pivoting staircase 10 to position the extension tread 102 between the lowermost tread 16 of the pivoting staircase 10 and the ground surface 40.

Releasably securing the tread extension assembly 100 to the pivoting staircase 10 includes securing the hooks 112 over the lowermost tread 16, such as over a rear edge thereof as shown or over a front edge. Further, the tread extension assembly 100 can be braced against the legs 56 of the pivoting staircase 10 and, if desired, can be secured using the lock member 124.

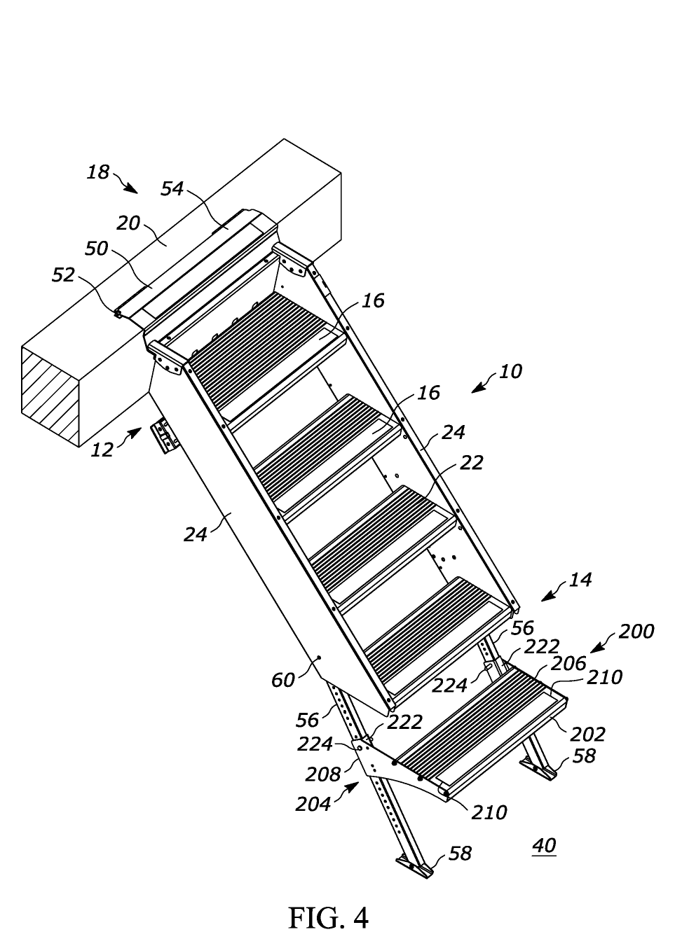

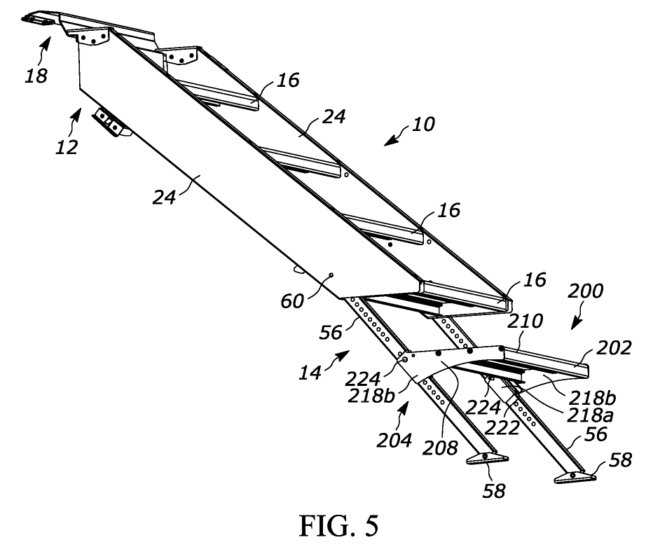

A second example extension tread assembly 200 is shown in FIGS. 4 and 5. The extension tread assembly 200 includes an extension tread 202 and a mount 204 configured to releasably couple the extension tread assembly 200 to the lower end 14 of the pivoting staircase 10 to position the extension tread 202 below lowermost tread 16 of the pivoting staircase 10. The extension tread 202 is coupled to the mount 204 and has an upper surface 206 configured to support a person thereon. As shown, the mount 204 includes bracket assemblies 208 coupled to lateral edges 210 of the extension tread 202.

The mount 204 includes braces 222 that are configured to engage and secure to the legs 56 of the staircase 10 to provide support for the extension tread 202. The braces 222 include a wall that rests on an upper surface of the legs 56 and at least an outer sidewall that extends along an outer surface of the leg 56. Further, the mount 204 includes a lock member 224 (e.g., pins (cotter), latches, etc.) that secure the mount 204 to the legs 56. For example, the mount 204 and legs 56 can include openings that align to receive the lock member 224 therethrough.

In some examples, the mount 204 further includes an interior wall, such that the braces 222 have a U-shaped configuration that extends around both sides of the legs 56. The U-shaped configuration provides additional lateral support to the extension tread assembly 200. The lock members 224 extend through the U-shaped configuration and the legs 56 to secure the mount 204 in place.

The legs 56 can include a number of openings therealong that can be used to receive the lock members 224 therethrough. Further, by selecting particular openings, a user can position the extension tread 202 at a desired distance from the lowermost tread 16 of the staircase 10 and from the ground surface 40.

As shown, the bracket assembly 208 can include inner and outer brackets 218a, 218b that secure together. The outer bracket 218b has a planar configuration. The outer bracket 218b is coupled to a lateral edge 210 of the extension tread 202 and extends along an outer surface of the adjacent leg 56. The inner bracket 218a has a bent configuration that includes a coupling wall to secure to the outer bracket 218b by any suitable mechanism (e.g., fasteners, welding, etc.), a transverse wall that extends along an upper surface of the leg 56, and an inner wall that extends along an interior surface of the leg 56. When the inner and outer brackets 218a, 218b are secured together, the brackets 218a, 218b capture the leg 56 therebetween.

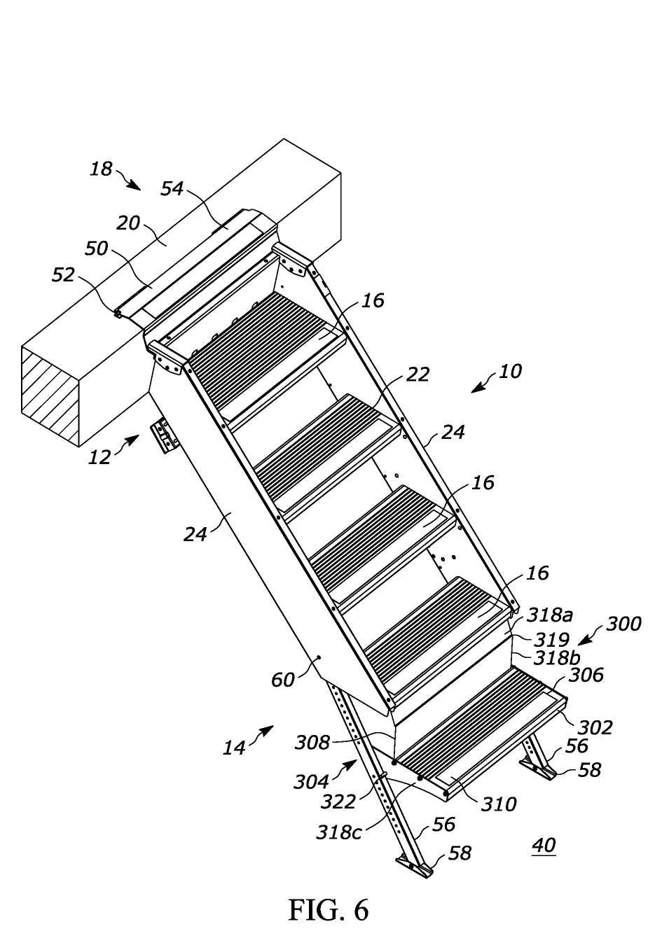

A third example extension tread assembly 300 is shown in FIGS. 6-9. The extension tread assembly 300 includes an extension tread 302 and a mount 304 configured to couple the extension tread assembly 300 to the lower end 14 of the pivoting staircase 10 to position the extension tread 302 below lowermost tread 16 of the pivoting staircase 10. The extension tread 302 is coupled to the mount 304 and has an upper surface 306 configured to support a person thereon. As shown, the mount 304 includes bracket assemblies 308 coupled to lateral edges 310 of the extension tread 302.

In this example, the mount 304 pivotably secures the extension tread 302 to the lowermost tread 16 of the staircase 10, such that the extension tread 302 is pivotable between a use position disposed below the lowermost tread 16 and a storage position resting on the upper surface 22 of the lowermost tread 16.

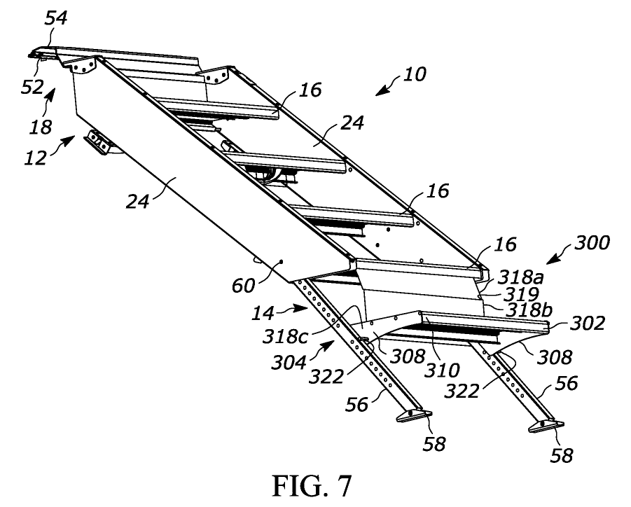

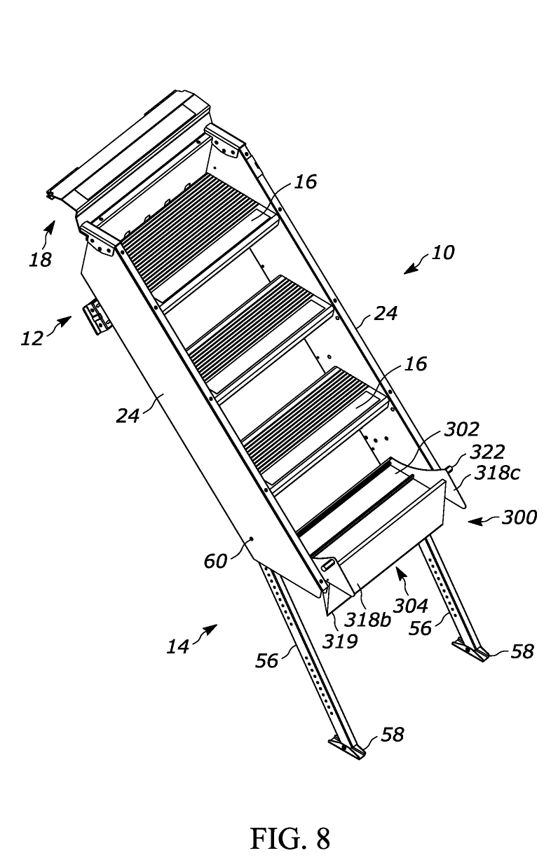

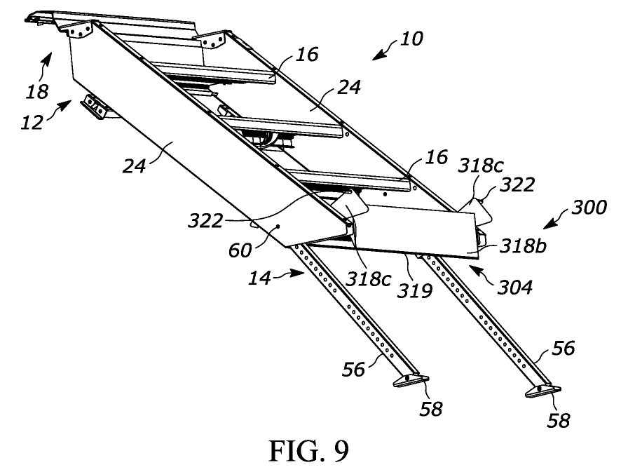

As shown, the bracket assembly 308 includes upper and lower plates 318a, 318b pivotably coupled together by a hinge 319. The upper plate 318a is secured to the lowermost tread 16 and the lower plate 318b is secured to the extension tread 302. The plates 318a, 318b can be secured by any suitable mechanism, such as welding, fasteners, etc. The upper and lower plates 318a, 318b are sized to position the extension tread 302 at a desirable height (e.g., a typical tread height) relative to the lowermost tread 16 in the use position as shown in FIGS. 6 and 7, as well as to rest the extension tread 302 on the lowermost tread 16 when in the storage position as shown in FIGS. 8 and 9.

Further, the mount 304 includes side brackets 318c that extend along an interior surface of the leg 56 and couple to the lateral edges 310 of the extension tread 302. Braces 322 are coupled to the side brackets 318c and are configured to engage upper surfaces of the legs 56 of the staircase 10 to provide support for the extension tread 302 when in the use position. The braces 322 can be a rod as shown, or can be a wall or other suitable structure.

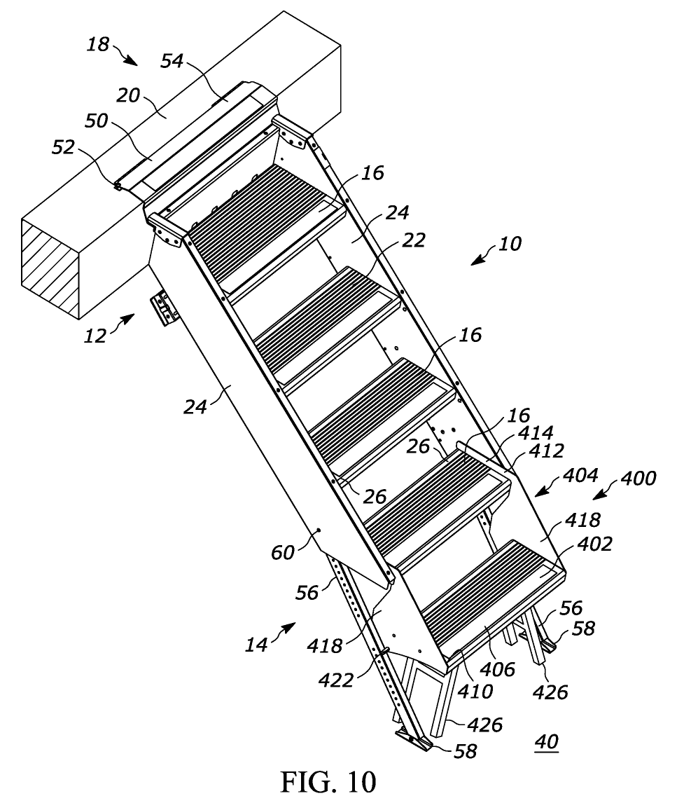

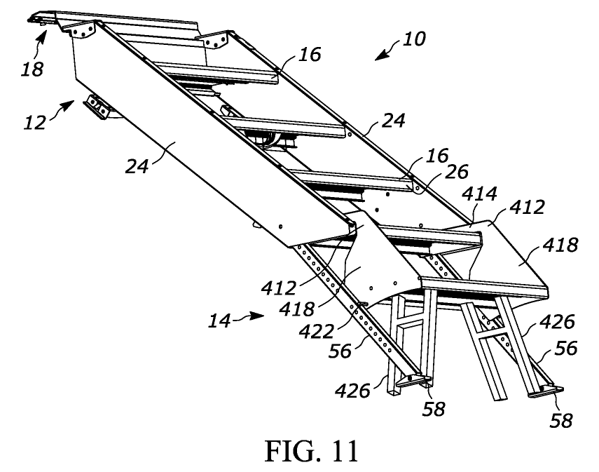

A fourth example extension tread assembly 400 is shown in FIGS. 10 and 11. The extension tread assembly 400 includes an extension tread 402 and a mount 404 configured to releasably couple the extension tread assembly 400 to the lower end 14 of the pivoting staircase 10 to position the extension tread 402 below lowermost tread 16 of the pivoting staircase 10. The extension tread 402 is coupled to the mount 404 and has an upper surface 406 configured to support a person thereon.

The mount 404 includes one or more hooks 412 that are configured to engage the lowermost tread 16. For example, the hooks 412 include an upper portion 414 that is configured to extend across the upper surface 22 of the lowermost tread 16. By one approach, the mount 404 includes two hooks 412 that extend over the lateral ends 26 of the tread 16. Of course, one central hook or more than two hooks could be utilized. Although not shown, the upper portions 414 of the hooks 412 can include a laterally extending flange, as with the above example. As shown, the hooks 412 of this example can be configured to extend around a front edge of the lowermost tread 16. Of course, the hooks 412 can also be configured to extend around a rear edge of the lowermost tread 16. Alternatively, the hooks 412 can be configured to connect to a lower surface of the tread 16, or the tread 16 can include one or more ledges, recesses, or cavities defined in or extending from the tread 16 to receive the hooks 412.

The mount 404 includes side brackets 418 that extend along an interior surface of the leg 56 and couple to lateral edges 410 of the extension tread 402. Braces 422 are coupled to the side brackets 418 and are configured to engage upper surfaces of the legs 56 of the staircase 10 to provide support for the extension tread 402. The braces 422 can be a rod as shown, or can be a wall or other suitable structure.

In some examples, the extension tread assembly 400 further includes one or more legs 426 that extend between the extension tread 402 and the ground surface 40. The legs 426 can be fixed in position relative to the extension tread 402, can be pivotably coupled to the extension tread 402 or at least partially collapsible to provide flexibility on the distance between the extension tread 402 and the ground surface 40, or can be releasably coupled to the extension tread 402 by any suitable mechanism, such as snap-fit, latches, tongue and groove, friction fit, etc. In any of the above forms, the legs 426 can be adjustable to vary a length thereof. For example, the legs 426 can include telescoping members, add-on portions, pivoting portions, and so forth.

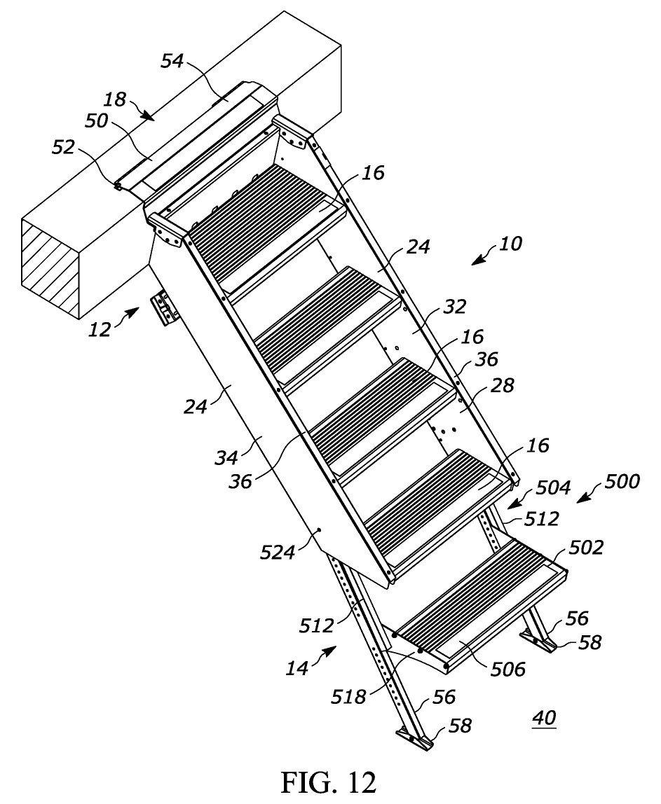

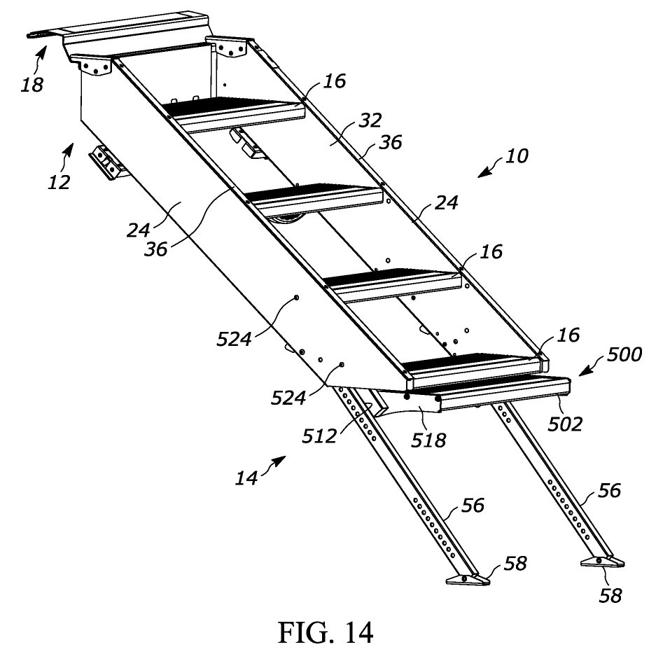

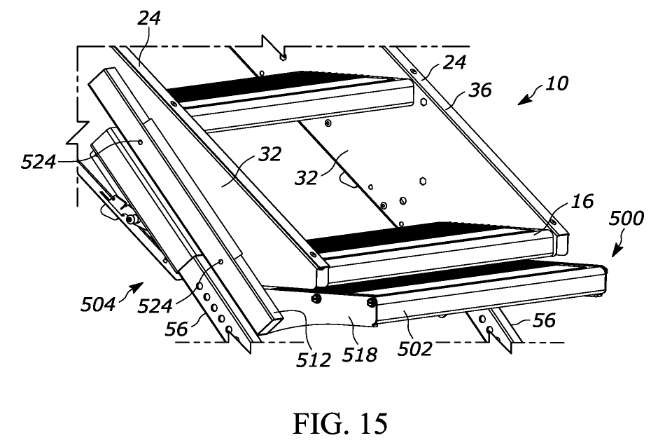

A fifth example extension tread assembly 500 is shown in FIGS. 12-15. The extension tread assembly 500 includes an extension tread 502 and a mount 504 configured to releasably couple the extension tread assembly 500 to the lower end 14 of the pivoting staircase 10 to position the extension tread 502 below the lowermost tread 16 of the pivoting staircase 10. The extension tread 502 is coupled to the mount 504 and has an upper surface 506 configured to support a person thereon.

The mount 504 of this example includes supports 512 that extend and retract relative to the stringers 24 of the staircase 10 to move the extension tread 502 between a storage position disposed closely adjacent or abutting the lowermost tread 16 and one or more use positions spaced below the lowermost tread 16. The supports 512 can have any suitable configuration. In some examples, the supports 512 telescope out from the interior 38 of the stringers 24 and are secured in place with a lock member 524, such as a pin or the like, extending through aligned openings in one or more walls 32, 34, 36 of the stringer 24 and the supports 512. The supports 512 can couple directly to the extension tread 502 or the mount 504 can include side brackets 518 that extend along an interior surface of the leg 56 and couple to the lateral edges 510 of the extension tread 502.

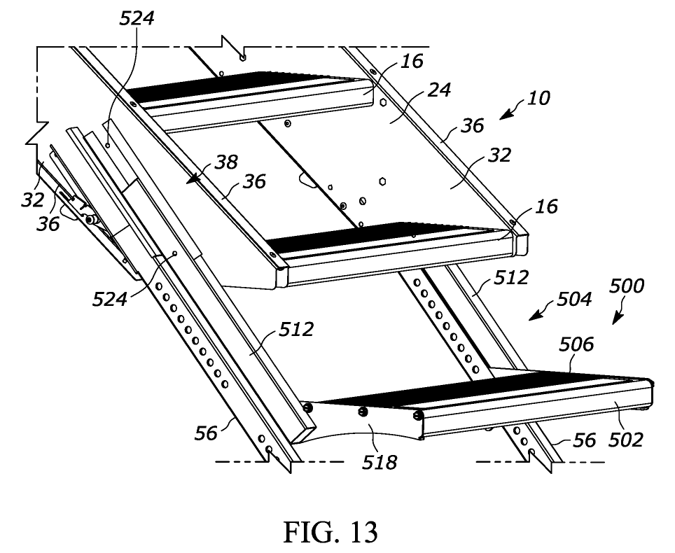

As shown in FIG. 13, the supports 512 can be movable along an axis that is angled relative to a longitudinal axis of the legs 56. With this configuration, the supports 512 abut the legs 56 when extended to a furthest use position. This engagement with the legs 56 advantageously provides additional support for the extension tread 502, as well as provides a stop for the supports 512 that can be utilized to correspond to a use position where openings in the supports 512 and the stringers 24 are aligned.

The treads described herein can have any suitable construction. For example, the treads can be made from plastic, metal, wood, a composite material, and so forth. The treads can include one, two, three, or more supports, which can be made from metal, such as aluminum. The supports can extend longitudinally and/or laterally with respect to the staircase.

The terms “substantially," "approximately," and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology. It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments.

The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples without departing from the scope of the claims. Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An extension assembly for a pivoting staircase having an upper end, a lower end, one or more treads, and a pivot connection at the upper end to pivotably couple the pivoting staircase to an elevated structure, the extension assembly comprising:
a mount configured to couple to the lower end of the pivoting staircase; and
an extension tread coupled to the mount and having an upper surface configured to support a person thereon, the mount configured to position the extension tread below a lowest one of the one or more treads of the pivoting staircase.

2. The extension assembly of claim 1, wherein the mount comprises bracket assemblies coupled to lateral edges of the extension tread.

3. The extension assembly of claim 2, wherein the bracket assemblies each include a plurality of brackets configured with a plurality of coupling locations, the plurality of coupling locations imparting different lengths to the bracket assemblies to position the extension tread at a plurality of distances from the lowest one of the one or more treads.

4. The extension assembly of claim 3, wherein the bracket assemblies each comprise an upper bracket configured to couple to the lowest one of the one or more treads, and a lower bracket configured to couple to one of the lateral edges of the extension tread.

5. The extension assembly of claim 1, wherein pivoting staircase includes legs configured to engage a ground surface adjacent to the pivoting staircase; and the mount includes braces configured to engage the legs to provide support for the extension tread.

6. The extension assembly of claim 5, wherein the braces have a U-shaped configuration to extend around the legs, and further comprising lock members configured to releasably couple to the braces to secure the bracket assemblies to the legs.

7. The extension assembly of claim 1, wherein the mount comprises one or more hooks configured to engage the lowest one of the one or more treads.

8. The extension assembly of claim 7, wherein the hooks include an upper portion configured to extend across an upper surface of the lowest one of the one or more treads.

9. The extension assembly of claim 8, wherein the upper portions of the hooks include laterally extending flanges configured to extend across the upper surface of the lowest one of the one or more treads.

10. The extension assembly of claim 7, wherein the hooks are configured to extend around a rear edge of the lowest one of the one or more treads.

11. A staircase assembly comprising:
a pivoting staircase comprising:
a pair of stringers;
one or more treads extending between the stringers;
a lower end adapted for contacting a ground surface and an upper end opposite the lower end; and
a hinge of the upper end configured to pivotably couple the pivoting staircase to an elevated structure; and
an extension assembly including an extension tread, the extension assembly configured to couple to the pivoting staircase, such that the extension tread is positioned below a lowest one of the one or more treads of the pivoting staircase.

12. The staircase assembly of claim 11, wherein the extension assembly further comprises bracket assemblies coupled to lateral edges of the tread, the bracket assemblies configured to couple to the pivoting staircase.

13. The staircase assembly of claim 12, wherein the bracket assemblies each include a plurality of brackets configured with a plurality of coupling locations, the plurality of coupling locations imparting different lengths to the bracket assemblies to position the extension tread at a plurality of distances from the lowest one of the one or more treads.

14. The staircase assembly of claim 12, wherein pivoting staircase includes legs at the lower end configured to engage the ground surface; and the bracket assemblies each include a brace configured to engage the legs to provide support for the extension tread.

15. The staircase assembly of claim 14, wherein the braces have a U-shaped configuration to extend around the legs, and the extension assembly further comprises lock members configured to releasably couple to the braces to secure the bracket assemblies to the legs.

16. The staircase assembly of claim 12, wherein the bracket assemblies each comprise a hook configured to engage the lowest one of the one or more treads.

17. A method comprising:
moving a pivoting staircase including one or more treads from a storage position to a use position contacting a ground surface; and
coupling an extension assembly including an extension tread to the pivoting staircase to position the extension tread between a lowest one of the one or more treads of the pivoting staircase and the ground surface.

18. The method of claim 17, wherein coupling the extension assembly to the pivoting staircase comprises securing one or more hooks coupled to the extension tread over the lowest one of the one or more treads.

19. The method of claim 17, wherein coupling the extension assembly to the pivoting staircase comprises bracing the extension assembly against legs of the pivoting staircase.

20. The method of claim 19, wherein bracing the extension assembly against the legs of the pivoting staircase comprises securing a lock member to a brace of the extension assembly engaging one of the legs of the pivoting staircase, such that the brace is releasably secured to the one of the legs.
